(19) United States
(12) Patent Application Publication
(10) Pub. No.: US 2026/0299989 A1
(43) Pub. Date: Oct. 1, 2026

(54) LEVERAGING SPARE EXTENDED PAGE-TABLE BITS

(71) Applicant: Palo Alto Networks, Inc., Santa Clara, CA (US)

(72) Inventor: Matthew Steven Leinhos, Fishers, IN (US)

(21) Appl. No.: 19/097,155

(22) Filed: Apr. 1, 2025

(51) Int. Cl. G06F 9/455

(52) U.S. Cl. CPC G06F 9/45558; G06F 2009/45562; G06F 2009/45583

(57) ABSTRACT

A virtual machine is instantiated. Pages of memory being accessed by the virtual machine are monitored. A hint stored in an extended page table associated with a page of the pages of memory being accessed by the virtual machine is inspected. A response to access of the page is based on the hint stored in the extended page table associated with the page.

### BACKGROUND OF THE INVENTION

The extended page-table (EPT) mechanism is a feature that can be used to support the virtualization of physical memory. When EPT is in use, certain addresses that would normally be treated as physical addresses (and used to access memory) are instead treated as guest-physical addresses. Guest-physical addresses are translated by traversing a set of EPT paging structures to produce physical addresses that are used to access memory. Each physical page mapped in EPT can have three explicit permissions: read, write, and execute.

Virtual Machine Introspection (VMI) is a technique that allows an external entity, such as a hypervisor, to monitor and analyze the internal state of a virtual machine (VM) without interfering with its normal operations. A hypervisor may utilize EPT to monitor regions of memory, of various sizes, for read, write, and execute access from the VM.

### BRIEF DESCRIPTION OF THE DRAWINGS

Various embodiments of the invention are disclosed in the following detailed description and the accompanying drawings.

FIG. 1 is an example of a page table entry in accordance with some embodiments.

FIG. 2 is an example of a hint in accordance with some embodiments.

FIG. 3 is a block diagram illustrating a system to leverage spare extended page-table bits in accordance with some embodiments.

FIG. 4 is a flow diagram illustrating a process to leverage spare extended page-table bits in accordance with some embodiments.

FIG. 5 is a flow diagram illustrating a process to leverage spare extended page-table bits for VMI region segmentation in accordance with some embodiments.

FIG. 6 is a flow diagram illustrating a process to introduce a halt instruction on an extended page table page in accordance with some embodiments.

FIG. 7 is a flow diagram illustrating a process to leverage spare EPT bits for faster halt handling in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A virtual machine monitor (VMM or hypervisor) includes a host kernel component and a host user component. The kernel space component has direct access to system resources and manages low-level operations, such as process scheduling, memory management, and hardware communication. The user space component is the portion of the VMM where applications and non-privileged processes execute. A hypervisor may interact with the host kernel component to perform analysis of the VM. In some scenarios, the analysis exits from the host kernel component to the host user component. Switching between kernel space and user space is costly in itself due to the need to save and restore the state of the current process. The hypervisor may need to perform security checks and validate privileged operations when exiting kernel space. This overhead further delays the transition to user space.

Systems and methods to reduce the number of transitions from the kernel space to user space are disclosed herein. The number of transitions from the from the kernel space to user space may be reduced by leveraging spare EPT bits.

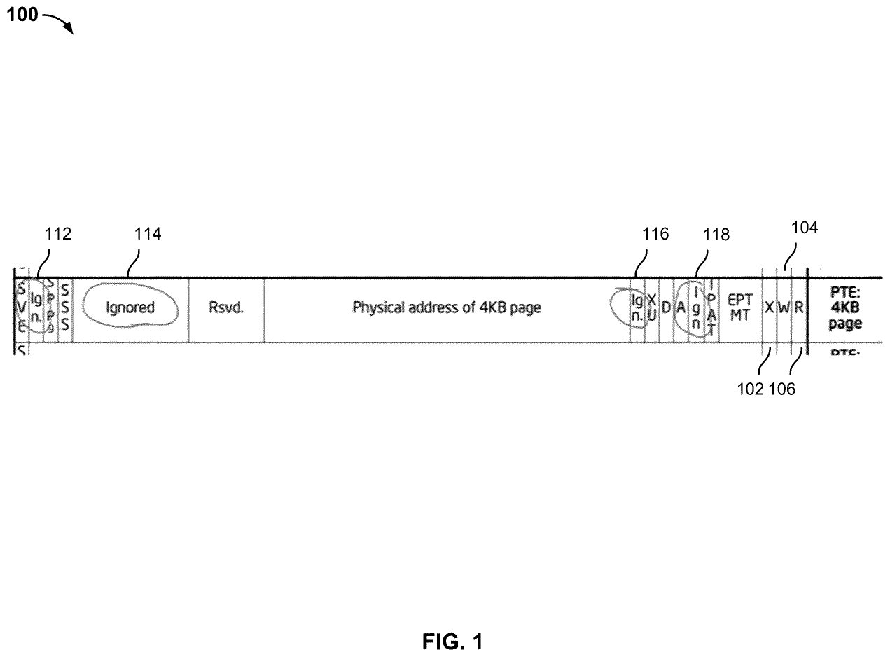

FIG. 1 is an example of a page table entry for a 4 KB page. Each page in an EPT can be marked as readable, writable, and/or executable so that host software can be notified about accesses of interest when they occur from the virtual machine. Page table entry 100 includes a first bit 102 that indicates whether the page is readable, a second bit 104 that indicates whether the page is writable, and a third bit 106 that indicates whether the page is executable. Page table entry 100 includes a plurality of spare bits 112, 114, 116, 118 that are ignored (e.g., not used or considered during memory translation) by the processor. The plurality of spare bits 112, 114, 116, 118 are located at different portions of page table entry 100.

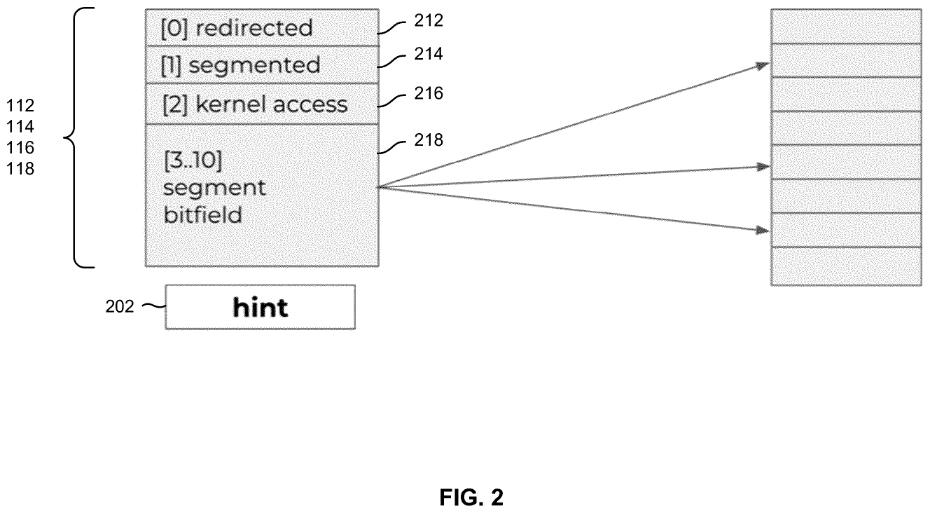

The plurality of spare bits 112, 114, 116, 118 are serialized and consolidated, as seen in FIG. 2, to form a hint 202. Hint 202 includes a redirected bit 212, a segmented bit 214, a kernel access bit 216, and a segment bitfield 218. The segment bitfield 218 is divided into a plurality of segments. In the example shown, the segment bitfield 218 is divided into eight segments, 512 bytes each.

A VMI application programming interface (API) may enable a hypervisor to monitor regions of memory, of various sizes, for read, write, or execute access from the guest (VM). A region of interest may range in size from one byte to a whole page.

The hypervisor determines whether a process or thread associated with the VM is attempting to read from or write to a memory address that it is not allowed to access. Previous systems exit from kernel space to user space in response to detecting any access violation. An application in user space will create an event and publish the event to an event queue. However, a user may not be concerned with all access violations. As a result, the VM may unnecessarily exit from kernel space to user space, wasting resources and time reporting an access violation that the user is not concerned about.

In some embodiments, the hypervisor may consult a hint, such as hint 202, to determine whether a R/W access violation is a violation that the user is concerned about. In response to determining that the access violation is not a violation that the user is concerned about, the hypervisor may step past the violation location by switching to a different EPT structure where all of the permissions are enabled (e.g., read, write, and execute are enabled for that particular page), perform a single step operation on the CPU to step past the violating instruction by relaxing the memory permissions for the particular page, and after the instruction has been executed successfully, the hypervisor restores the original EPT to resume normal memory access controls.

In some embodiments, the hypervisor may consult a hint, such as hint 202, to determine whether an execution access is a violation that the user is concerned about. The execution access may be caused by the hypervisor or by the VM software itself. In response to determining that the execution access is not a violation that the user is concerned about (e.g., caused by the VM software itself), an instruction associated with the execution access is processed. In some embodiments, the instruction associated with the execution access is a halt instruction while the VM is in kernel mode. A CPU associated with the VM triggers a VM exit in response to the halt instruction. Control is transferred from the VM to the hypervisor. In some embodiments, the instruction associated with the execution access is a general protection fault while the VM is in user mode. The hypervisor traps this fault by causing a VM exit. Instead of handling the fault directly, the hypervisor reflects the fault back to the vCPU, which means that the fault is treated as if it originated from the vCPU itself and the virtual CPU behaves as if the fault happened within the VM, even though it was caused by an illegal operation from the guest OS. In response to a determining that the execution access is a violation that the user is concerned about, the VM exits from kernel space to user space. An application in user space will create an event of the execution access violation and publish the event to an event queue. Thus, utilizing the hint to determine whether the execution access is a violation that the user is concerned about reduces the number of times that the VM exits from kernel space to user space because the VM will only exit from kernel space to user space for execution access violations that are of interest to the user.

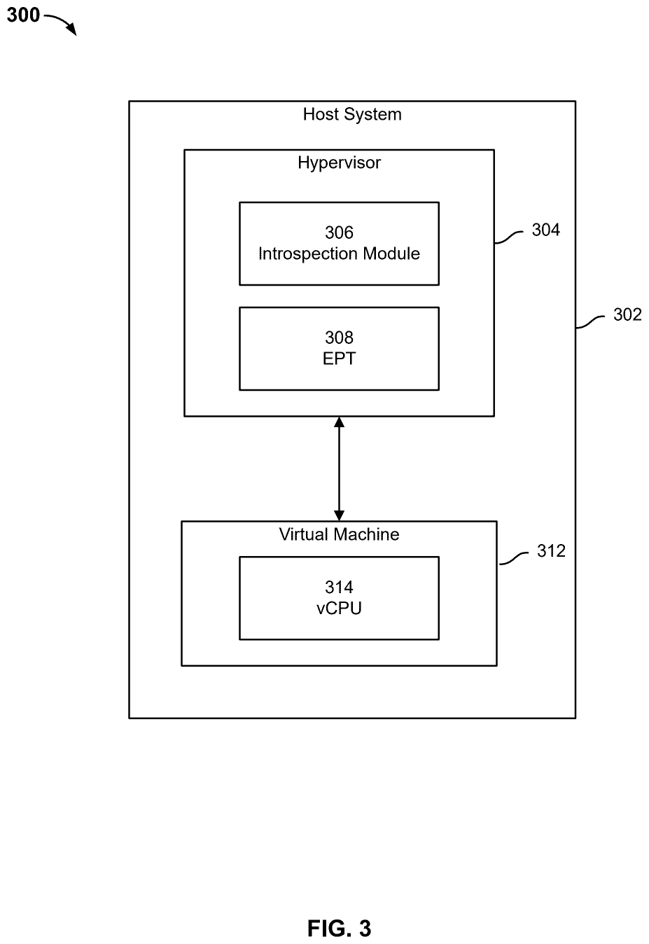

FIG. 3 is a block diagram illustrating a system to leverage spare extended page-table bits in accordance with some embodiments. In the example shown, system 300 includes a host system 302. Host system 302 is a physical server, bare-metal server, workstation, etc., on which hypervisor 304 runs. Hypervisor 304 is software that creates and manages virtual machines (e.g., virtual machine 312) on host system 302. In some embodiments, hypervisor 304 runs directly on the physical hardware of host system 302, without the need for an underlying operating system. In some embodiments, hypervisor 304 runs on top of an operating system associated with host system 302. The host operating system is responsible for managing the hardware and the hypervisor runs as an application within the host operating system.

Hypervisor 304 includes an VMI API that allows a user to monitor regions of memory, of various sizes, for read, write, or execute access from virtual machine 312. Regions of interest may range in size from one byte to a whole page (e.g., a virtual page of memory). Hypervisor 304 manages the mapping between virtual machine 312's virtual pages and host system 302's physical pages via electronic page tables 308. When virtual machine 312 accesses memory, the CPU of host system 302 performs a page table walk, first looking at the page tables associated with an operating system of virtual machine 312 and then looking at EPT 308 to complete the translation to the physical memory associated with host system 302. Virtual machine 314 includes vCPU that acts as the processing unit that executes instructions in the context of the guest operating system running on virtual machine 314.

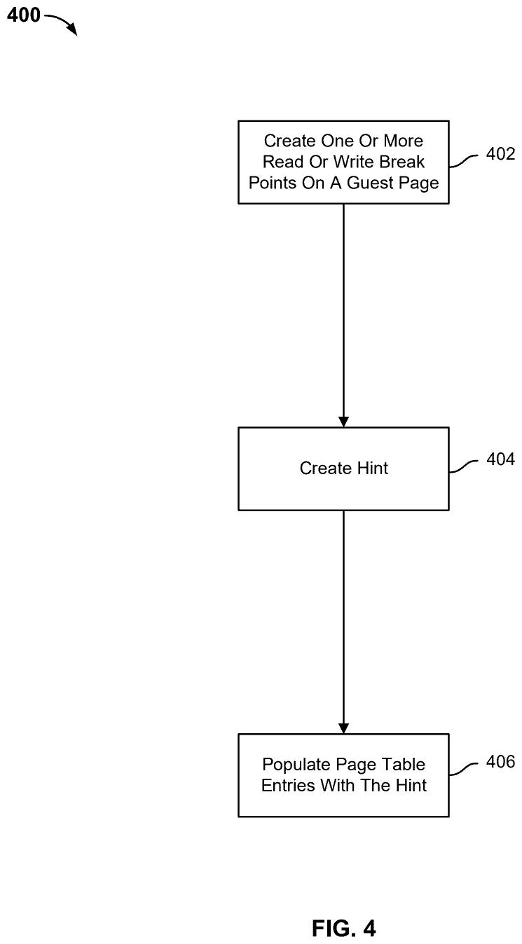

FIG. 4 is a flow diagram illustrating a process to leverage spare extended page-table bits in accordance with some embodiments. Process 400 may be implemented by a hypervisor, such as hypervisor 304. Process 400 may be implemented for a plurality of guest pages associated with a virtual machine.

At 402, one or more break points on created on a guest page. A break point on a guest page in a virtualized environment refers to a mechanism that allows the hypervisor to halt or interrupt the execution of a VM when certain conditions are met, typically when the CPU accesses a specific memory location or instruction in the guest OS.

In some embodiments, the break point is a read break point. In some embodiments, the break point is a write break point. In some embodiments, the break point is an execute break point.

Creating a breakpoint on a guest page includes populating some or all of the spare bits associated with the EPT. In some embodiments, a segmented bit is set to “1”. This indicates that the hypervisor has populated the segment bitfield. The value stored by the segment bitfield indicates which segments of the page that the VPI API has indicated interest in.

In some embodiments, a redirected bit is set to “1”. This indicates that the hypervisor has installed its own copy of the page. The segmented bit may also be set to “1”. This indicates that the hypervisor has populated the segment bitfield. The value stored by the segment bitfield indicates which segments of the page contain the halt instructions that the hypervisor introduced.

At 404, a hint is created. The plurality of spare bits associated with the EPT are serialized and consolidated to form a hint. The hint includes a redirected bit, a segmented bit, a kernel access bit, and a segment bitfield.

At 406, a page table entry is populated with the hint. The page table entry corresponding to the guest page is populated with the hint.

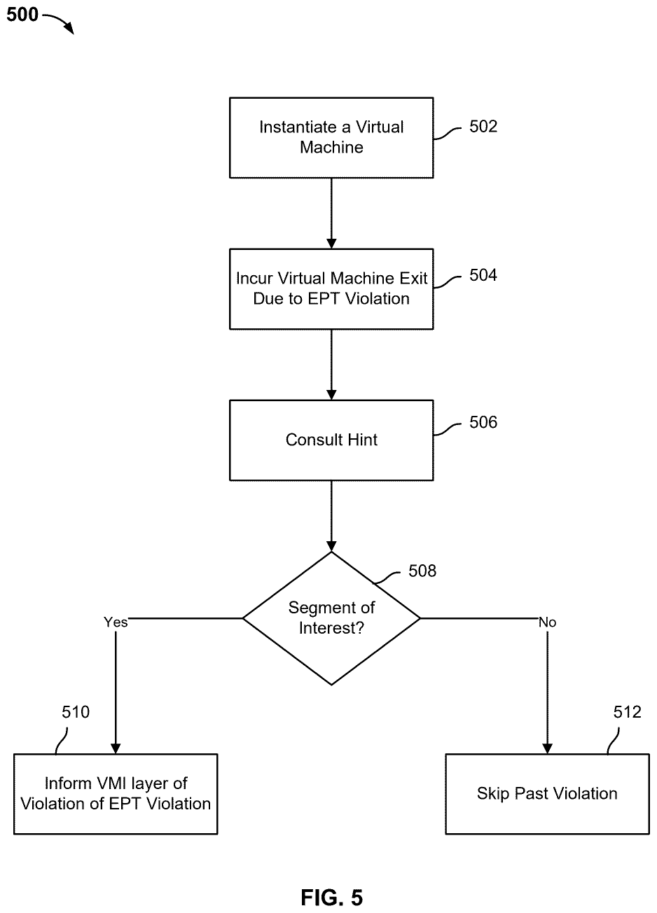

FIG. 5 is a flow diagram illustrating a process to leverage spare EPT bits for VMI region segmentation in accordance with some embodiments. Process 500 may be implemented by a hypervisor, such as hypervisor 304.

At 502, a virtual machine is instantiated. A hypervisor allocates resources, such as CPU, memory, storage, and network bandwidth for the virtual machine. The hypervisor loads the virtual disk and initializes an OS boot sequence. The hypervisor provides the virtual machine with virtualized CPU, memory, storage, network interface, and possibly GPU resources. The VM starts up. The virtual machine is connected to a virtual network. Once the OS is fully booted, users or applications can interact with the virtual machine.

At 504, a virtual machine exit is incurred due to an EPT violation. A virtual machine exit happens when a virtual machine operation triggers an event that requires intervention from the hypervisor. An EPT violation is one such event that causes a VM exit. Each EPT entry has read, write, and execute permissions. If the virtual machine attempts an operation that violates these permissions, an EPT violation occurs.

At 506, a hint is consulted. The EPT page associated with the EPT violation includes a plurality of spare bits. The spare bits are consolidated to form the hint. The hint includes a segmented bit and a segment bitfield. The segmented bit indicates whether the hypervisor has populated the segment bitfield. The segment bitfield indicates which segments of the page the VMI API has indicated interest in.

At 508, it is determined whether there is a segment of interest. In response to a determination there is a segment of interest, process 500 proceeds to 510. The hypervisor determines that there is a segment of interest in response to reading the segmented bit of the hint and the segmented bit of the hint indicates that the segment bitfield has been populated.

In response to a determination there is not a segment of interest, process 500 proceeds to 512. The hypervisor determines that there is not a segment of interest in response to reading the segmented bit of the hint and the segmented bit of the hint does not indicate that the segment field has been populated.

At 510, the VMI layer is informed of the EPT violation. The VMI layer is a hypervisor-based monitoring and analysis layer that allows the hypervisor to inspect and interact with the guest virtual machine's memory, CPU state, and execution flow without needing cooperation from the guest OS. The virtual machine exits from kernel space to user space. An application or module in user space processes the EPT violation by creating an event and publishing the event to an event queue.

At 512, the violation is skipped over. Skipping over an EPT violation means bypassing or resolving the violation in a way that allows the guest VM to continue execution without triggering a VM exit or fault handling mechanism. The hypervisor skips over the violation by switching over to a different extended page table structure where all permissions are enabled, performing a single step operation on the CPU to step past the violating instruction by relaxing the memory permissions for the particular page, and after the instruction has been executed successfully, restoring the original EPT to resume normal memory access controls. As a result, the VM does not need to unnecessarily exit from kernel space to user space, which would waste resources and time reporting an access violation that the user is not concerned about.

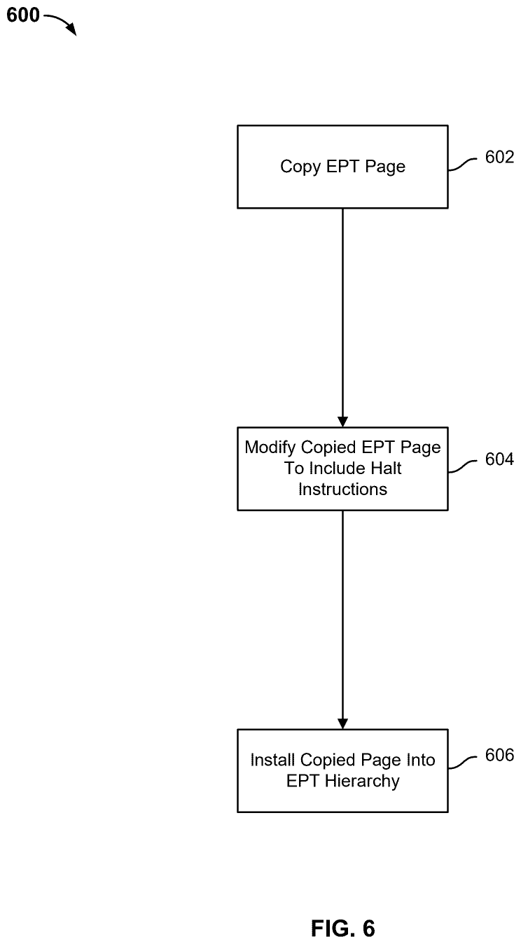

FIG. 6 is a flow diagram illustrating a process to introduce a halt instruction on an extended page table page in accordance with some embodiments. Process 600 may be implemented by a hypervisor, such as hypervisor 304.

At 602, an EPT page is copied. Copying an EPT page involves duplicating the mapping information that the hypervisor maintains for guest physical memory.

At 604, the copied EPT page is modified to include halt instructions. An EPT entry associated with the copied EPT page is modified to include read, write, and/or execute permissions. This allows writing a halt instruction and ensures the guest OS can execute it. A target instruction is overwritten with the halt instruction to introduce a halt. Once the guest OS executes the halt instruction, the vCPU enters a low-power state, and control returns to the hypervisor via a VM exit.

At 606, the copied page is installed into the EPT hierarchy. The EPT structures within the hypervisor are now updated with the copied page so that the VM can access the copied page instead of the original EPT page.

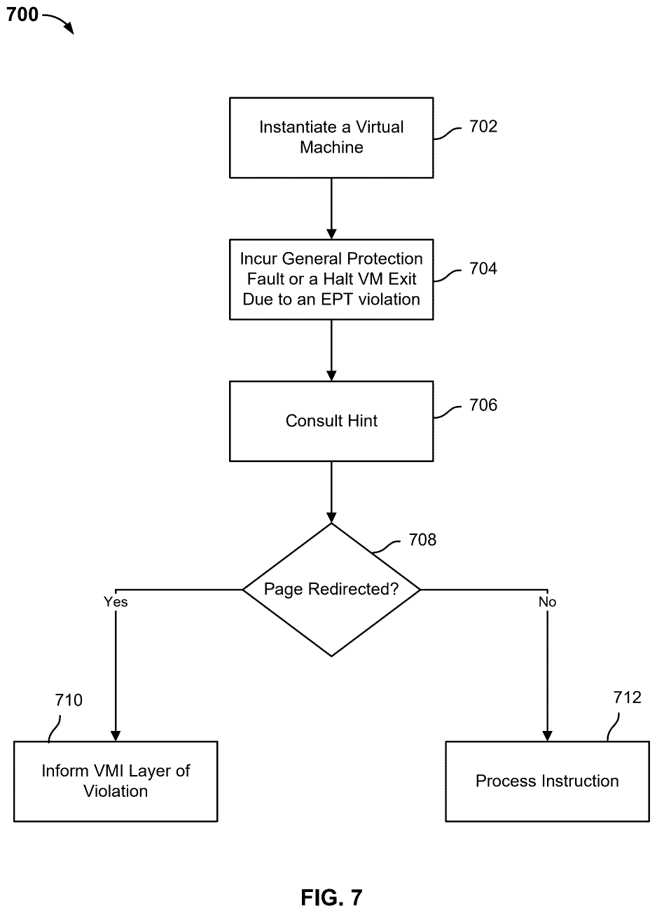

FIG. 7 is a flow diagram illustrating a process to leverage spare EPT bits for faster halt handling in accordance with some embodiments. Process 700 may be implemented by a hypervisor, such as hypervisor 304.

At 702, a virtual machine is instantiated. A hypervisor allocates resources, such as CPU, memory, storage, and network bandwidth for the virtual machine. The hypervisor loads the virtual disk and initializes an OS boot sequence. The hypervisor provides the virtual machine with virtualized CPU, memory, storage, network interface, and possibly GPU resources. The VM starts up. The virtual machine is connected to a virtual network. Once the OS is fully booted, users or applications can interact with the virtual machine.

At 704, a general protection fault or a halt VM exit is incurred due to an EPT violation. In some embodiments, the vCPU is executing in a kernel mode and the hypervisor incurs a halt VM exit. In some embodiments, the vCPU is executing in user mode and the hypervisor incurs a hardware exception VM exit from a general protection fault that the vCPU generates.

At 706, a hint is consulted. The hypervisor needs to determine if the VM exit is due to an analysis breakpoint or from non-analysis code. The EPT page associated with the EPT violation includes a plurality of spare bits. The spare bits are consolidated to form the hint. The hint includes a redirected bit, a segmented bit, and a segment bitfield. The redirected bit indicates whether the hypervisor has installed its own copy of the page. The segmented bit indicates whether the hypervisor has populated the segment bitfield. The segment bitfield indicates which segments of the page the VMI API has indicated interest in.

At 708, it is determined whether the page is redirected. The hypervisor inspects the redirected bit of the hint to determine whether the page is redirected. In response to a determination that the page is redirected, process 700 proceeds to 710. The redirected bit of the hint stores a value indicating that the page is redirected. In response to a determination that the page is not redirected, process 700 proceeds to 712. The redirected bit of the hint does not store a value indicating that the page is redirected.

At 710, the VMI layer is informed of the violation. The VMI layer is a hypervisor-based monitoring and analysis layer that allows the hypervisor to inspect and interact with the guest virtual machine's memory, CPU state, and execution flow without needing cooperation from the guest OS. The virtual machine exits from kernel space to user space. An application or module in user space processes the EPT violation by creating an event and publishing the event to an event queue.

At 712, the instruction is processed as a real halt instruction of a general protection fault that needs to be reflected back to the vCPU.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
instantiating a virtual machine;
monitoring pages of memory being accessed by the virtual machine;
inspecting a hint stored in an extended page table associated with a page of the pages of memory being accessed by the virtual machine; and
responding to access of the page based on the hint stored in the extended page table associated with the page.

2. The method of claim 1, wherein the extended page table associated with the page includes a plurality of spare bits, wherein the plurality of spare bits are consolidated to form the hint.

3. The method of claim 1, wherein the access of the page is a read access or a write access.

4. The method of claim 3, wherein the access of the page causes a virtual machine exit due to an extended page table violation.

5. The method of claim 4, wherein the hint includes a segmented bit and a segment bitfield.

6. The method of claim 5, wherein inspecting the hint stored in the extended page table associated with the page includes inspecting the segmented bit associated with the hint.

7. The method of claim 6, wherein in response to the segmented bit associated with the hint indicating that the segment bitfield has been populated, responding to access of the page based on the hint stored in the extended page table associated with the page includes informing a virtual machine introspection layer of the extended page table violation.

8. The method of claim 6, wherein in response to the segmented bit associated with the hint indicating that the segment bitfield has been populated, responding to access of the page based on the hint stored in the extended page table associated with the page includes skipping past the extended page table violation.

9. The method of claim 1, wherein the access of the page is an execution access.

10. The method of claim 9, wherein the access of the page causes a general protection fault of a halt virtual machine exit due to an extended page table violation.

11. The method of claim 10, wherein the hint includes a redirected bit.

12. The method of claim 11, wherein inspecting the hint stored in the extended page table associated with the page includes inspecting the redirected bit associated with the hint.

13. The method of claim 12, wherein in response to the redirected bit associated with the hint indicating that the page is redirected, responding to access of the page based on the hint stored in the extended page table associated with the page includes informing a virtual machine introspection layer of the extended page table violation.

14. The method of claim 12, wherein in response to the redirected bit associated with the hint indicating that the page is not redirected, responding to access of the page based on the hint stored in the extended page table associated with the page includes processing a halt instruction.

15. A system, comprising:
a processor configured to:
instantiate a virtual machine;
monitor pages of memory being accessed by the virtual machine;
inspect a hint stored in an extended page table associated with a page of the pages of memory being accessed by the virtual machine; and
respond to access of the page based on the hint stored in the extended page table associated with the page.
a memory coupled to the processor and configured to provide the processor with instructions.

16. The system of claim 15, wherein the extended page table associated with the page includes a plurality of spare bits, wherein the plurality of spare bits are consolidated to form the hint.

17. The system of claim 15, wherein the access of the page is a read access or a write access.

18. The system of claim 17, wherein the processor is configured to respond to the access of the page based on a segmented bit associated with the hint.

19. The system of claim 15, method of claim 1, wherein the access of the page is an execution access.

20. The system of claim 19, wherein the processor is configured to respond to the access of the page based on a redirected bit associated with the hint.

21. A computer program product embodied in a non-transitory computer readable medium and comprising computer instructions for:
instantiating a virtual machine;
monitoring pages of memory being accessed by the virtual machine;
inspecting a hint stored in an extended page table associated with a page of the pages of memory being accessed by the virtual machine; and
responding to access of the page based on the hint stored in the extended page table associated with the page.
